(19) United States
(12) Patent Application Publication
(10) Pub. No.: US 2019/0228428 A1
(43) Pub. Date: Jul. 25, 2019

(54) METHODS AND SYSTEMS FOR CREATING, PUBLISHING, AND REDEEMING INCENTIVE MARKETING OFFERS

(71) Applicants: David Wayne Bruner, Provo, UT (US); Nickolas David Bruner, Provo, UT (US); Trevor Noland Stott, Saratoga Springs, UT (US)

(72) Inventors: David Wayne Bruner, Provo, UT (US); Nickolas David Bruner, Provo, UT (US); Trevor Noland Stott, Saratoga Springs, UT (US)

(21) Appl. No.: 16/253,068

(22) Filed: Jan. 21, 2019

Related U.S. Application Data
(60) Provisional application No. 62/620,913, filed on Jan. 23, 2018.

(51) Int. Cl. G06Q 30/02

(52) U.S. Cl. CPC G06Q 30/0215; G06Q 30/0222

(57) ABSTRACT

Methods and systems for managing electronic computer-based incentive marketing campaigns are provided. In particular, one embodiment comprises a method that validates redemption of an offer based on a location of a consumer computing device correlating to a vendor location. Another embodiment comprises a method that provides an offer to a consumer computing device based on a response from a consumer account to a survey. Another embodiment comprises a method that distributes and validates redemption of an offer based on a consumer account being associated with a network to which the offer is to be distributed. A further embodiment comprises a method that denies a request to redeem an offer until a pre-determined period of time has elapsed. One or more other embodiments comprise methods and systems that improve the creation, publication, distribution, validation, redemption, and overall management of digital incentive marketing offers.

### CROSS-REFERENCE TO RELATED APPLICATIONS

This application claims the benefit of, and priority to, U.S. Provisional Patent Application Ser. No. 62/620,913, entitled “Customized System for Creating, Controlling, Managing and Monitoring Incentive Marketing Campaigns by a Multitude of Vendors,” filed Jan. 23, 2018, the entire contents of which are hereby expressly incorporated by reference.

### BACKGROUND

### 1. Field

One or more embodiments generally relate to the field of electronic computer-based incentive marketing campaign methods and systems and, more particularly, to methods and systems for creating, publishing, and redeeming incentive marketing offers.

### 2. Background and Relevant Art

With the advent and advances made in computing technology, many entities, particularly vendors of goods and services, are looking for effective ways to deliver digital incentive marketing offers (i.e., offers), such as digital coupons, incentives, and loyalty or reward points, to current and potential customers. Some vendors have created their own mobile applications for this purpose. However, typical consumers are very particular about how many mobile applications they will download on their mobile computing devices. Therefore, the prospect of reaching new customers with a vendor-specific mobile application is usually very low. Though there are a number of entities providing offers through mobile applications, such applications typically have certain limitations. For example, vendors using such applications are oftentimes limited in the number and type of offers they may provide and when and how often they may add such offers. As a more specific example, vendors using such applications may be able to offer coupons for goods and services, but not be able to offer loyalty or rewards programs for repeat customers. The participating vendors using such applications are also not fully in control of how and what is being offered, as typically the offers have to be negotiated, approved, and uploaded by a third party. This limits vendors and consumers with respect to options and flexibility desirable to both parties.

Vendors are also concerned about redemptions from a computing device being secured, recorded, and properly monitored. For example, many vendors do not have technology in place to scan codes from consumer mobile computing devices and those that do may have concerns about a single offer being used more than once by the same consumer.

Thus, methods and systems are needed to provide entities, such as vendors, with the ability to control and manage their own incentive marketing campaigns. More specifically, methods and systems are needed to reach out to targeted groups of consumers by offering desired coupons, incentives, loyalty or reward points, and other incentive marketing offers without overwhelming consumers with multiple vendor-specific mobile application requirements. Moreover, methods and systems are needed to make access to the provided offerings simple and appealing to consumers. Also, methods and systems are needed to provide entities with easy-to-use and effective control over all incentive marketing campaigns distributed to mobile computing devices of consumers, especially with respect to validating the redemption of offers by consumers.

Furthermore, methods and systems are needed to gather and provide data to entities with options for reaching out to specific groups of consumers based on the data gathered and provided. Also, methods and systems are needed to allow entities to add and change offers in real-time based on the determined effectiveness of each incentive marketing campaign. Moreover, methods and systems are needed to enable entities to set campaigns to run according to parameters preset by them.

Even more specifically, one problem with conventional incentive marketing methods and systems is that they are oftentimes unable to effectively validate the redemption of offers by consumers, which in some cases leads to consumers redeeming offers more than was originally desired by the vendor, thereby resulting in a loss of control over the incentive marketing campaign by the vendor.

Another problem with conventional incentive marketing methods and systems is that they typically lack a sufficient ability to effectively target the right consumers. Consequently, conventional incentive marketing methods and systems usually result in distributing offers to a significant number of consumers who are unlikely to ultimately redeem the offers.

In view of problems such as those noted above, and others, it would be useful to provide methods and systems for managing electronic computer-based incentive marketing campaigns that effectively validate redemption of an offer using a consumer's location and a vendor's location. Moreover, it would also be useful to provide methods and systems for managing electronic computer-based incentive marketing campaigns that provide an offer to a consumer based on the consumer's response to a survey. Furthermore, it would be useful to provide methods and systems for managing electronic computer-based incentive marketing campaigns that effectively target the right consumers who are likely to redeem offers. Therefore, conventional methods and systems for managing electronic computer-based incentive marketing campaigns have various limitations that are desirable to overcome.

### BRIEF SUMMARY

Embodiments provide benefits or solve one or more of the foregoing or other problems in the art with methods and systems for managing electronic computer-based incentive marketing campaigns. In one aspect, one or more embodiments include a method for managing electronic computer-based incentive marketing campaigns including comparing a location of a consumer computing device and a vendor location and validating redemption of an offer based on a determination the location of the consumer computing device correlates to the vendor location. More specifically, the method includes providing an offer to a mobile application of a consumer computing device, the mobile application associated with a consumer account, the offer created by a vendor account to motivate consumers to make purchases from a vendor associated with the vendor account. The method further includes receiving a request to redeem the offer. Additionally, the method includes determining a location of the consumer computing device associated with the request and determining a vendor location associated with the request. Thus, the method includes comparing, by one or more processors, the location of the consumer computing device and the vendor location to determine the location of the consumer computing device correlates to the vendor location. Even further, the method includes validating redemption of the offer based on the determination the location of the consumer computing device correlates to the vendor location. Accordingly, one or more embodiments include a method that effectively validates redemption of an offer using a consumer's location and a vendor's location.

In another aspect, one or more embodiments include a method for managing electronic computer-based incentive marketing campaigns including providing an offer based on a response from a consumer account to a survey. In particular, the method includes providing, by one or more processors, an offer to a mobile application of a consumer computing device, the mobile application associated with a consumer account, the offer created by a vendor account to motivate consumers to make purchases from a vendor associated with the vendor account, the offer provided based on a response from the consumer account to a survey. Additionally, the method includes receiving a request to redeem the offer. Moreover, the method includes determining a location of the consumer computing device associated with the request and determining a vendor location associated with the request. Furthermore, the method includes comparing, by the one or more processors, the location of the consumer computing device and the vendor location to determine the location of the consumer computing device correlates to the vendor location. Still further, the method includes validating redemption of the offer based on the determination the location of the consumer computing device correlates to the vendor location. Accordingly, one or more embodiments include a method that provides an offer to a consumer based on the consumer's response to a survey.

In yet a further aspect, one or more embodiments include a system for managing electronic computer-based incentive marketing campaigns including a non-transitory storage medium including instructions that cause the system to compare a location of a consumer computing device and a vendor location and validate redemption of an offer based on a determination the location of the consumer computing device correlates to the vendor location. More specifically, the system includes one or more server computing devices executing a network application and a non-transitory storage medium. Further, the non-transitory storage medium includes instructions that, when executed by the one or more server computing devices, cause the system to provide an offer to a mobile application of a consumer computing device, the mobile application associated with a consumer account, the offer created by a vendor account to motivate consumers to make purchases from a vendor associated with the vendor account. Moreover, the instructions cause the system to receive a request to redeem the offer. Furthermore, the instructions cause the system to determine a location of the consumer computing device associated with the request and determine a vendor location associated with the request. Additionally, the instructions cause the system to compare the location of the consumer computing device and the vendor location to determine the location of the consumer computing device correlates to the vendor location. Additionally, the instructions cause the system to validate redemption of the offer based on the determination the location of the consumer computing device correlates to the vendor location. Thus, one or more embodiments include a system that effectively validates redemption of an offer using a consumer's location and a vendor's location.

In yet another aspect, one or more embodiments include a method for managing electronic computer-based incentive marketing campaigns including distributing an offer to a consumer account based on a determination that the consumer account is associated with a network to which the offer is to be distributed and validating redemption of the offer based on the determination that the consumer account is associated with the network to which the offer is to be distributed. More specifically, the method includes creating an offer to motivate consumers to make purchases from a vendor associated with a vendor account, the offer created based on offer information received from the vendor account. The method further includes receiving, from the vendor account, an indication of a network to which the offer is to be distributed and determining a network identification code that identifies the network. The method also includes receiving, from a mobile application associated with a consumer account, an indication of the network identification code that identifies the network, associating the consumer account with the network based on receipt of the indication of the network identification code that identifies the network, and distributing the offer to the consumer account based on a determination that the consumer account is associated with the network to which the offer is to be distributed. Moreover, the method includes receiving a request to redeem the offer for the consumer account and validating redemption of the offer based on the determination that the consumer account is associated with the network to which the offer is to be distributed. Accordingly, one or more embodiments include a method that more effectively targets the right consumers who are likely to redeem offers.

In an additional aspect, one or more embodiments include a method for managing electronic computer-based incentive marketing campaigns including determining that an offer is available for multiple redemptions by a consumer account and denying a subsequent request to redeem the offer for the consumer account until a pre-determined period of time has elapsed since an initial request to redeem the offer for the consumer account. In particular, the method includes creating an offer to motivate consumers to make purchases from a vendor associated with a vendor account, the offer created based on offer information received from the vendor account. The method also includes receiving, from the vendor account, an indication of a network to which the offer is to be distributed and determining a network identification code that identifies the network. Moreover, the method includes receiving, from a mobile application associated with a consumer account, an indication of the network identification code that identifies the network, associating the consumer account with the network based on receipt of the indication of the network identification code that identifies the network, and distributing the offer to the consumer account based on a determination that the consumer account is associated with the network to which the offer is to be distributed. Furthermore, the method includes receiving an initial request to redeem the offer for the consumer account and validating redemption of the offer based on the determination that the consumer account is associated with the network to which the offer is to be distributed. Additionally, the method includes determining that the offer is available for multiple redemptions by the consumer account and denying a subsequent request to redeem the offer for the consumer account until a pre-determined period of time has elapsed since the initial request to redeem the offer for the consumer account. Accordingly, one or more embodiments include a method that more effectively validates the redemption of offers by consumers, especially in circumstances involving multiple redemptions of the same offer by the same consumer.

In another additional aspect, one or more embodiments include a system for managing electronic computer-based incentive marketing campaigns including a non-transitory storage medium including instructions that cause the system to distribute an offer to a consumer account based on a determination that the consumer account is associated with a network to which the offer is to be distributed and validate redemption of the offer based on the determination that the consumer account is associated with the network to which the offer is to be distributed. More specifically, the system includes one or more server computing devices executing a network application and a non-transitory storage medium. Further, the non-transitory storage medium includes instructions that, when executed by the one or more server computing devices, cause the system to create an offer to motivate consumers to make purchases from a vendor associated with a vendor account, the offer created based on offer information received from the vendor account. Moreover, the instructions cause the system to receive, from the vendor account, an indication of a network to which the offer is to be distributed and determine a network identification code that identifies the network. Furthermore, the instructions cause the system to receive, from a mobile application associated with a consumer account, an indication of the network identification code that identifies the network, associate the consumer account with the network based on receipt of the indication of the network identification code that identifies the network, and distribute the offer to the consumer account based on a determination that the consumer account is associated with the network to which the offer is to be distributed. Additionally, the instructions cause the system to receive a request to redeem the offer for the consumer account and validate redemption of the offer based on the determination that the consumer account is associated with the network to which the offer is to be distributed. Accordingly, one or more embodiments include a system that more effectively targets the right consumers who are likely to redeem offers.

Additional features and advantages of exemplary embodiments will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages, aspects, and features can be obtained, a more particular description will be rendered by reference to specific embodiments that are illustrated in the appended drawings. Understanding that these drawings depict only example embodiments and are not therefore to be considered limiting in scope, embodiments will be described and explained with additional specificity and detail through the use of the accompanying drawings in which:

FIG. 1 illustrates an example method and system of offer creation and publication in accordance with one or more embodiments;

FIG. 2 illustrates an example method and system of offer creation and delivery in accordance with one or more embodiments;

FIG. 3 illustrates an example method and system of offer redemption in accordance with one or more embodiments;

FIG. 4 illustrates an example method and system of consumer network creation in accordance with one or more embodiments;

FIG. 5 illustrates an example method and system of offer reservation in accordance with one or more embodiments;

FIG. 6 illustrates an example method and system of offer reservation without a data connection in accordance with one or more embodiments;

FIG. 7 illustrates an example method and system of offer delivery in accordance with one or more embodiments;

FIG. 8 illustrates an example method and system of vendor location addition in accordance with one or more embodiments;

FIG. 9 illustrates an example method and system of user addition in accordance with one or more embodiments;

FIG. 10 illustrates an example user hierarchy and permissions in accordance with one or more embodiments;

FIG.11 illustrates an example method and system of post-offer redemption automatic offer uploading in accordance with one or more embodiments;

FIG. 12 illustrates an example method and system of offer redemption validation by vendor proximity in accordance with one or more embodiments;

FIG. 13 illustrates a block diagram of an exemplary computing device in accordance with one or more embodiments; and

FIG. 14 illustrates an example network environment of an incentive marketing networking system in accordance with one or more embodiments.

### DETAILED DESCRIPTION

One or more embodiments provide methods and systems that improve management of electronic computer-based incentive marketing campaigns. In one aspect, one or more embodiments provide a method that effectively validates redemption of an offer using a consumer's location and a vendor's location. More specifically, one or more embodiments include a method for managing electronic computer-based incentive marketing campaigns including providing an offer to a mobile application of a consumer computing device, the mobile application associated with a consumer account, the offer created by a vendor account to motivate consumers to make purchases from a vendor associated with the vendor account. Moreover, the method includes receiving a request to redeem the offer. Furthermore, the method includes determining a location of the consumer computing device associated with the request and determining a vendor location associated with the request. Also, the method includes comparing, by one or more processors, the location of the consumer computing device and the vendor location to determine the location of the consumer computing device correlates to the vendor location. Even further, the method includes validating redemption of the offer based on the determination the location of the consumer computing device correlates to the vendor location.

Additionally, in one or more embodiments, validating redemption of the offer based on the determination the location of the consumer computing device correlates to the vendor location can include returning a redemption method to the consumer computing device in response to the request to redeem the offer and receiving a vendor identifier from the consumer computing device, the vendor identifier input into the consumer computing device using the redemption method. The redemption method can include a text input trigger that initiates use of a textbox to provide the vendor identifier as input into the consumer computing device. Also, the redemption method can include a scanner trigger that initiates use of a scanner of the consumer computing device to read the vendor identifier as input into the consumer computing device. The scanner can include a camera of the computing device. The vendor identifier can be one of a QR code, a bar code, a uniquely identifiable image, or a text code. Also, the method can further include receiving an employee identifier from the consumer computing device.

Furthermore, in one or more embodiments, validating redemption of the offer based on the determination the location of the consumer computing device correlates to the vendor location can include returning a redemption code to the consumer computing device in response to the request to redeem the offer and receiving the redemption code from a vendor computing device located at the vendor location. The redemption code can be one of a QR code, a bar code, a uniquely identifiable image, or a text code.

In another aspect, one or more embodiments provide a method that provides an offer to a consumer based on the consumer's response to a survey. In particular, one or more embodiments include a method for managing electronic computer-based incentive marketing campaigns including providing, by one or more processors, an offer to a mobile application of a consumer computing device, the mobile application associated with a consumer account, the offer created by a vendor account to motivate consumers to make purchases from a vendor associated with the vendor account, the offer provided based on a response from the consumer account to a survey. Moreover, the method includes receiving a request to redeem the offer. Furthermore, the method includes determining a location of the consumer computing device associated with the request and determining a vendor location associated with the request. Also, the method includes comparing, by one or more processors, the location of the consumer computing device and the vendor location to determine the location of the consumer computing device correlates to the vendor location. Even further, the method includes validating redemption of the offer based on the determination the location of the consumer computing device correlates to the vendor location.

Additionally, in one or more embodiments, the method can include providing the survey through the mobile application of the consumer computing device, receiving the response from the consumer account to the survey, and determining the response indicates the offer is compatible with the consumer account. Determining the response indicates the offer is compatible with the consumer account can include determining a redemption probability associated with the offer with respect to the consumer account. The redemption probability can be determined based on at least one of the response from the consumer account to the survey provided through the mobile application of the consumer computing device, an offer redemption history of the consumer account, or a network membership of the consumer account.

Also, in one or more embodiments, the method can include identifying consumer GPS coordinates of the location of the consumer computing device associated with the request, identifying vendor GPS coordinates of the vendor location associated with the request, and determining that the consumer GPS coordinates and the vendor GPS coordinates are sufficiently proximate to indicate the consumer GPS coordinates correlate to the vendor GPS coordinates.

In yet a further aspect, one or more embodiments provide a system that effectively validates redemption of an offer using a consumer's location and a vendor's location. More specifically, one or more embodiments include a system for managing electronic computer-based incentive marketing campaigns including one or more server computing devices executing a network application and a non-transitory storage medium. The non-transitory storage medium includes instructions that, when executed by the one or more server computing devices, cause the system to perform various functions. The instructions cause the system to provide an offer to a mobile application of a consumer computing device, the mobile application associated with a consumer account, the offer created by a vendor account to motivate consumers to make purchases from a vendor associated with the vendor account. The instructions also cause the system to receive a request to redeem the offer. Moreover, the instructions cause the system to determine a location of the consumer computing device associated with the request and determine a vendor location associated with the request. Furthermore, the instructions cause the system to compare the location of the consumer computing device and the vendor location to determine the location of the consumer computing device correlates to the vendor location. Even further, the instructions cause the system to validate redemption of the offer based on the determination the location of the consumer computing device correlates to the vendor location.

Additionally, in one or more embodiments, the system can include instructions that cause the system to receive offer information from the vendor account, create the offer based on the offer information, and store the offer in a database. The system can also include instructions that cause the system to receive publication information from the vendor account and distribute the offer to the mobile application of the consumer computing device in accordance with the publication information. Also, the system can include instructions that cause the system to determine a characteristic for membership in a private network, determine the consumer account associated with the mobile application shares the characteristic, distribute an invitation to join the private network to the consumer account based on the determination the consumer account shares the characteristic, receive an acceptance of the invitation to join the private network, and associate the consumer account with the private network in order for the consumer account to receive offers directed to the private network. Furthermore, the system can include instructions that cause the system to receive a reservation of the offer, the reservation of the offer associated with the consumer account, and reduce a number of available offers associated with the offer by one based on the reservation of the offer associated with the consumer account.

In yet another aspect, one or more embodiments provide a method that more effectively targets the right consumers who are likely to redeem offers, based on the consumers association with one or more networks. More specifically, one or more embodiments include a method for managing electronic computer-based incentive marketing campaigns including creating an offer to motivate consumers to make purchases from a vendor associated with a vendor account, the offer created based on offer information received from the vendor account. The method further includes receiving, from the vendor account, an indication of a network to which the offer is to be distributed and determining a network identification code that identifies the network. The method also includes receiving, from a mobile application associated with a consumer account, an indication of the network identification code that identifies the network, associating the consumer account with the network based on receipt of the indication of the network identification code that identifies the network, and distributing the offer to the consumer account based on a determination that the consumer account is associated with the network to which the offer is to be distributed. Moreover, the method includes receiving a request to redeem the offer for the consumer account and validating redemption of the offer based on the determination that the consumer account is associated with the network to which the offer is to be distributed.

Additionally, in one or more embodiments, the method can further include providing a vendor portal that facilitates the input of information related to creating, publishing, and redeeming offers. Also, the method can include creating one or more vendor locations based on vendor location information received from the vendor account, wherein the vendor location information includes physical addresses where offers of the vendor are redeemable. Moreover, the method can include creating a vendor profile based on vendor account information received from the vendor account, wherein the vendor account information includes at least one of logos, artwork, images, or text related to the vendor. The offer information can include at least one of text wording of the offer, an offer start date, an offer expiration date, or a number of redemptions of the offer available per consumer account. Also, the method can include receiving, from the vendor account, a request to immediately publish the offer to one or more consumer accounts and, in response to the receipt of the request to immediately publish the offer, providing the offer to a mobile application associated with each of the one or more consumer accounts. Also, the method can include receiving, from the vendor account, a request for future publication of the offer to one or more consumer accounts and providing the offer to a mobile application associated with each of the one or more consumer accounts in accordance with the request for future publication of the offer. The request for future publication of the offer can specify a date and time for publication of the offer to the one or more consumer accounts. Also, the request for future publication of the offer can specify a period of time that must elapse before publication of the offer to the one or more consumer accounts.

In an additional aspect, one or more embodiments provide a method that more effectively validates the redemption of offers by consumers, especially in circumstances involving multiple redemptions of the same offer by the same consumer. In particular, one or more embodiments include a method for managing electronic computer-based incentive marketing campaigns including creating an offer to motivate consumers to make purchases from a vendor associated with a vendor account, the offer created based on offer information received from the vendor account. The method also includes receiving, from the vendor account, an indication of a network to which the offer is to be distributed and determining a network identification code that identifies the network. Moreover, the method includes receiving, from a mobile application associated with a consumer account, an indication of the network identification code that identifies the network, associating the consumer account with the network based on receipt of the indication of the network identification code that identifies the network, and distributing the offer to the consumer account based on a determination that the consumer account is associated with the network to which the offer is to be distributed. Furthermore, the method includes receiving an initial request to redeem the offer for the consumer account and validating redemption of the offer based on the determination that the consumer account is associated with the network to which the offer is to be distributed. Additionally, the method includes determining that the offer is available for multiple redemptions by the consumer account and denying a subsequent request to redeem the offer for the consumer account until a pre-determined period of time has elapsed since the initial request to redeem the offer for the consumer account.

Additionally, in one or more embodiments, determining a network identification code that identifies the network can further include generating the network identification code at a host server. Also, determining a network identification code that identifies the network can further include receiving data input that specifies the network identification code, wherein the data input is received from one of the vendor account or a host provider. The method can also include receiving, from the mobile application associated with the consumer account, a request to reserve the offer, reserving the offer for redemption by the consumer account, determining that a pre-determined period of time has elapsed since the receipt of the request to reserve the offer, and removing the offer from the consumer account based on the determination that the pre-determined period of time has elapsed since the receipt of the request to reserve the offer, and placing the offer into a pool of offers available for use by other consumer accounts. Moreover, the method can include receiving, from the vendor account, a selection of a redemption process to apply to the offer. The redemption process can include sending, to the mobile application associated with the consumer account, a request to display a notification of redemption that causes the mobile application to display a redemption code. The method can also include receiving, from the vendor account, information indicating that the redemption code has been scanned by a vendor computing device located at a vendor location associated with the vendor account of the vendor. Also, the redemption process can include receiving, from the mobile application associated with the consumer account, information indicating that a redemption code displayed at a vendor location associated with the vendor account of the vendor has been scanned by a consumer computing device having the mobile application associated with the consumer account. Additionally, the redemption process can include determining that a consumer computing device is in communication with a vendor computing device located at a vendor location associated with the vendor account of the vendor, the consumer computing device having the mobile application associated with the consumer account.

In another additional aspect, one or more embodiments provide a system that more effectively targets the right consumers who are likely to redeem offers, based on the consumers association with one or more networks. More specifically, one or more embodiments include a system for managing electronic computer-based incentive marketing campaigns including one or more server computing devices executing a network application and a non-transitory storage medium. The non-transitory storage medium includes instructions that, when executed by the one or more server computing devices, cause the system to perform various functions. The instructions cause the system to create an offer to motivate consumers to make purchases from a vendor associated with a vendor account, the offer created based on offer information received from the vendor account. Moreover, the instructions cause the system to receive, from the vendor account, an indication of a network to which the offer is to be distributed and determine a network identification code that identifies the network. Furthermore, the instructions cause the system to receive, from a mobile application associated with a consumer account, an indication of the network identification code that identifies the network, associate the consumer account with the network based on receipt of the indication of the network identification code that identifies the network, and distribute the offer to the consumer account based on a determination that the consumer account is associated with the network to which the offer is to be distributed. Additionally, the instructions cause the system to receive a request to redeem the offer for the consumer account and validate redemption of the offer based on the determination that the consumer account is associated with the network to which the offer is to be distributed.

Additionally, in one or more embodiments, the system can include instructions that cause the system to provide a vendor portal that facilitates the input of information related to creating, publishing, and redeeming offers.

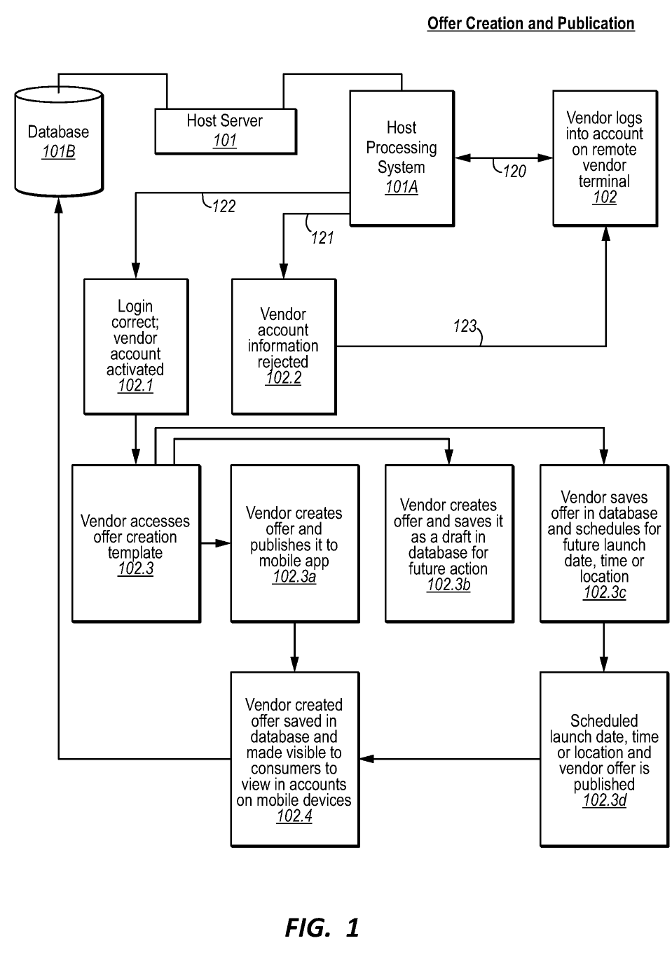

Turning to FIGS. 1-14, various configurations and aspects of one or more embodiments are depicted.

FIG. 1 illustrates an example method and system of offer creation and publication in accordance with one or more embodiments. More specifically, FIG. 1 illustrates a process of a vendor logging into a vendor account on a host processing system, accessing an offer creation template provided by a host provider, and options available for managing an offer. FIG. 1 shows the vendor attempting to login to its account on the host processing system 101A from a remote vendor terminal 102. To login to its account, the vendor connects through an electronic communications network 120 to a host server 101 that includes host processing system 101A and database 101B provided by a host provider. If the vendor fails to login correctly 121 the login attempt is rejected 102.2 and the vendor is provided with an error message and prompted to login again 123. Otherwise, the vendor login is accepted 122 and the vendor account is activated 102.1. The vendor then accesses the offer creation template 102.3 to create an offer to place in the database 101B of host processing system 101A.

The vendor then has several options on how to proceed with the offer being created. One option for offer creation and publication is that the vendor may complete and immediately publish the offer 102.3 a in which case the offer is saved in the database 101B and made visible to consumers chosen by the vendor to view in their consumer accounts through a mobile application on their mobile computing devices 102.4. These consumers may then login to their consumer accounts through the mobile application and view the offer uploaded by the vendor.

Another option for offer creation and publication is that the vendor may decide to finish creating the offer at a different time and save the offer as a draft 102.3b. In this case, the offer will show in the vendor's created offers section of the vendor's account as being in draft status waiting for further action.

Yet another option for offer creation and publication is that the vendor may also choose to schedule the offer for a future launch date to be launched automatically at the date and time scheduled by the vendor as shown in 102.3c. The vendor may also schedule the offer for a future launch location to be launched automatically when a particular consumer is determined to be at a specific geographic location or area, typically near one of the vendor's locations. This allows the vendor to create a marketing plan through strategic planning for making the desired offers appear to the targeted consumers, individually and as groups, at the times and locations the vendor feels will most likely have a positive impact on patronage at the vendor locations. This also allows the Vendor to do longer term marketing strategies in one login session. Once the scheduled launch dates or locations are reached, the offers are published 102.3d, saved in database 101B, and received by consumers through their associated consumer accounts in the host processing system 101A and the mobile application on their mobile computing devices to redeem as desired and within the guidelines set by the vendor 102.4.

The actual methods and systems may vary, but vendors will have multiple options for creating, viewing, and distributing offers to consumers in ways that vendors feel are most advantageous to their needs and strategies. The methods and systems allow for each vendor to create a multitude of offers and publish them to the consumer accounts at any given time. The methods and systems also allow for a multitude of vendors to create and upload offers at the convenience of each vendor. Vendors may also have the opportunity to manage offers so that they are only visible to consumers during times the offers are valid. For example, if an offer is good for 30 days and the vendor does not want the offer used on Friday, or Saturday night, the vendor may have the option to have the offer not be visible at those times by choosing such option as provided by the host provider through the host processing system 101A on the host server 101.

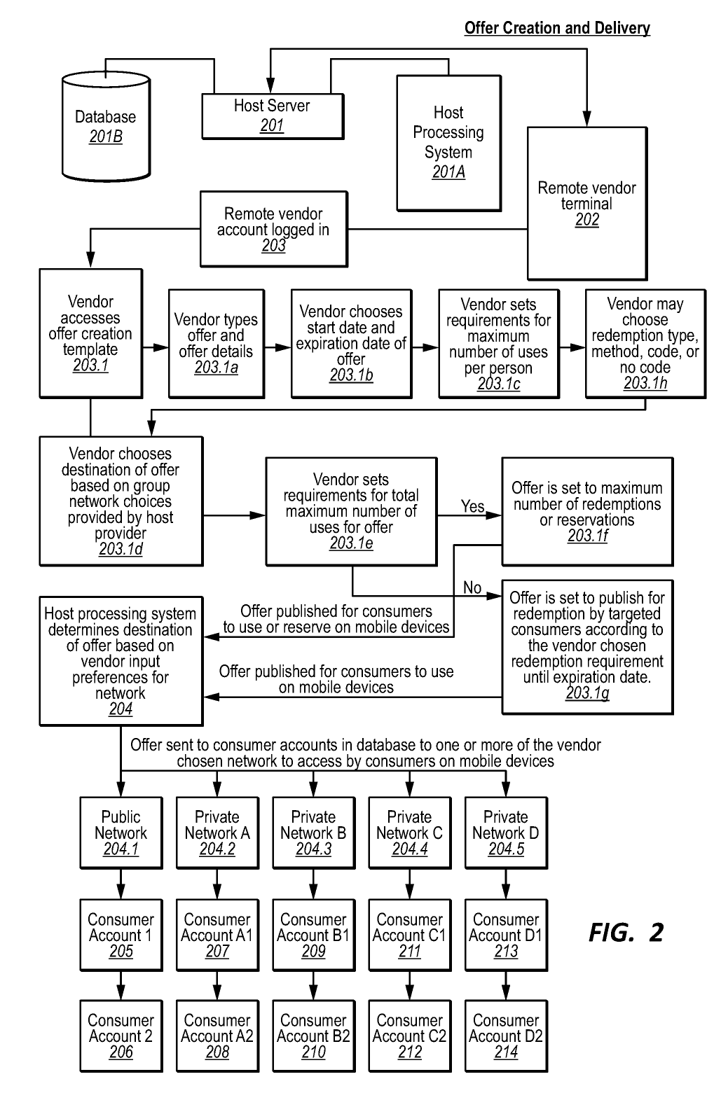

FIG. 2 illustrates an example method and system of offer creation and delivery in accordance with one or more embodiments. In particular, FIG. 2 illustrates that once a vendor utilizing a remote vendor terminal 202 is logged into 203 the host processing system 201A of host server 201, the vendor may access the offer creation template 203.1 and type into the fields provided the desired offers with all of the details as chosen by the vendor 203.1a. At least some of these details may be created by the vendor or may also be provided in templates for the vendor to use, the templates provided by the host provider on the host server 201. As part of offer creation, the vendor may choose the start date and expiration date of each offer 203.1b. The host processing system 201A offered by the host provider may also provide blocks of time for the vendor to choose from for determining the time frames and expiration dates of the vendor created offers. The vendor also sets requirements on the maximum number of times an individual consumer may use each offer 203.1c. The vendor may then choose the method for the way a consumer may redeem the offer 203.1h. The host processing system 201A may default to a specific redemption method, if the vendor does not choose a particular method for consumers to redeem the offer. Some fields may also be required to be completed before the vendor is allowed to save, schedule, or publish an offer.

Once the vendor has created the offer, the vendor may then choose to send the offer to all consumers participating in the host processing system 201A through a public network, or may choose one or more private networks through which only consumers belonging to those networks may see the provided offers 203.1d. Networks may include, but are not limited to, business professionals, teachers, college students, public service personnel, military personnel, medical professionals, etc. Networks may also simply consist of groupings of one or more consumers who share one or more characteristics. The vendor may then choose the maximum number of redemptions that all consumers may have by limiting the total number of a specific offer 203.1e. A specific offer with total maximum use requirements may be available to consumers to either redeem or reserve for redemption. Thus, the specific offer may then be set to a maximum number of redemptions or reservations 203.1f and thus, the availability of the offer is decreased by one after each consumer redemption or reservation related to using the offer. If the vendor chooses to not set a total maximum number of uses, the offer is set to be published for consumer use under the terms and until the expiration date set by the vendor 203.1g.

Once the vendor chooses the option to publish the offer, the host processing system 201A analyzes the data provided by the vendor, determines how the offer is to be presented, and the networks to where the offer is to be sent, according to the data provided by the vendor 204. The offer is then sent to the desired consumer accounts tied to the networks chosen by the vendor for the dissemination of the offer. For example, the offer may be distributed to public network 204.1, private network 204.2, private network 204.3, private network 204.4, or private network 204.5. Consumer accounts 205, 206, 207, 208, 209, 210, 211, 212, 213, and 214 correspond to membership in each network, respectively. Though each network shows specific consumer members, some consumer members may belong to multiple networks. For example, the consumer account 208 shown through consumer account A2 as belonging to private network A 204.2 could also belong to private network C 204.4. All consumers are members of the public network 204.1.

The opportunity to have network options for offer distribution to choose from by vendors when creating and publishing offers provides a significant advantage to the vendors when creating marketing strategies to bring specific types of customers to their vendor locations. For example, college students may not act and purchase the same way that a business professional would. College students, because of limited budgets, may need a much more aggressive offering from the vendor to act on the offer than would a business professional. In this case, the option of choosing networks for offer distribution allows the vendor to be more aggressive in publishing offers to students and maybe less aggressive with the business professionals so that the vendor does not have to spend as much in advertising to entice business professionals with their offerings.

Vendors may also prefer one group, or network of consumers to patronize their vendor locations over others. Networks also provide vendors with the opportunity to create goodwill in the community and loyal customer bases. For example, on teacher appreciation week, vendors may create and publish high value offers only available to teachers to express their appreciation for their service in the community. Vendors may also choose to do the same for military personnel and public service personnel like firefighters and police offers.

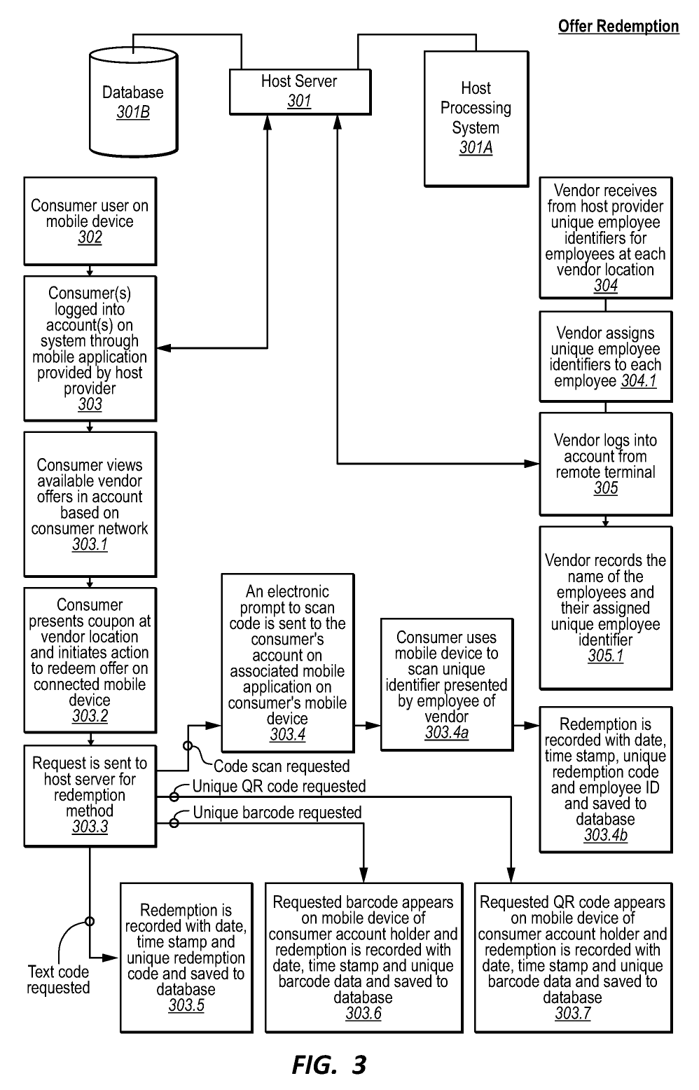

FIG. 3 illustrates an example method and system of offer redemption in accordance with one or more embodiments. More specifically, FIG. 3 illustrates potential options for vendors to choose how consumers may redeem offers at the vendor's participating locations. In one or more embodiments, the vendor may receive from the host provider unique employee identifiers in the form of physical instruments, such as plastic cards, or badges, or digital devices containing unique codes, such as RFIDs, QR codes, or barcodes, to provide to each employee that will be accepting offer redemptions from consumers 304. The vendor may then assign each unique employee identifier to individual employees 304.1. The Vendor may then login to the host processing system 301A found on the host server 301 provided by the host provider from a remote vendor terminal 305. Vendor may then record in the host processing system 301A the assigned unique identifiers with the associated employee names or identities 305.1.

FIG. 3 also illustrates a consumer with a mobile computing device 302, who logs into their account on the host processing system 301A through the mobile application provided by the host provider 303 and views vendor provided offers available to the consumer's member networks 303.1. In this illustration, the consumer is connected through with data access to the host processing system 301A through the host provider's mobile application on the consumer's mobile computing device. The consumer visits a participating vendor location and initiates an action to redeem the vendor's offer under the terms required by the vendor 303.2. Once the redemption action is initiated by the consumer, a request is sent via a data connection to the host server 301 to receive a redemption method 303.3. The host processing system 301A then returns a redemption method to the consumer's mobile computing device associated with the consumer account through the mobile application as required by vendor.

In one scenario, the mobile application resident on the consumer's mobile computing device may interact with other software or hardware on the consumer's mobile computing device to initiate scanning capabilities so that the consumer may scan the unique vendor identifier or employee identifier (e.g., QR code, barcode, text code) presented to the consumer by an employee of vendor 303.4. Once the presented unique vendor identifier or employee identifier is scanned by the consumer 303.4a, the redemption is recorded on the host server 301 (i.e., saved to database 301B) with time stamp, unique redemption code, and any other useful information, such as employee identifier, etc. 303.4b.

Also, the host processing system 301A may receive request 303.3 and return to the consumer's mobile computing device through the mobile application through a data connection a redemption code, such as a barcode 303.6 or a QR code 303.7, which will be scanned by an employee of vendor to record in the vendor account of the host processing system 301A managed by the vendor. In this case, once the code is delivered, the database 301B on the host server 301 managed by the host provider may be updated with the recorded redemption, including date, time stamp, and unique code associated with the provided QR code or barcode.

As another alternative, the redemption is completed manually by pressing a confirmation key on either the vendor's terminal (i.e., vendor computing device) or the consumer's mobile application on the consumer's mobile computing device, and the redemption is then recorded on the database 301B of host server 301 with time, date, and unique redemption code 303.5.

Having different redemption options allows vendors to choose which option best fits their systems, processes, and business practices. For example, a car wash may only utilize self-serve scanning of barcodes or QR codes to provide offers to consumers. The other options of redeeming offers (i.e., those requiring vendor employee involvement) would not be functional in this case. In a different context, a restaurant owner or manager may want to ensure that all of the employees are accepting and recording offers correctly and may want to require greater accountability by having the employee utilize the assigned unique employee identifier to redeem an offer. The owner or manager could then also analyze the total transactions related to a specific employee while including the offers redeemed by the employee in the analysis.

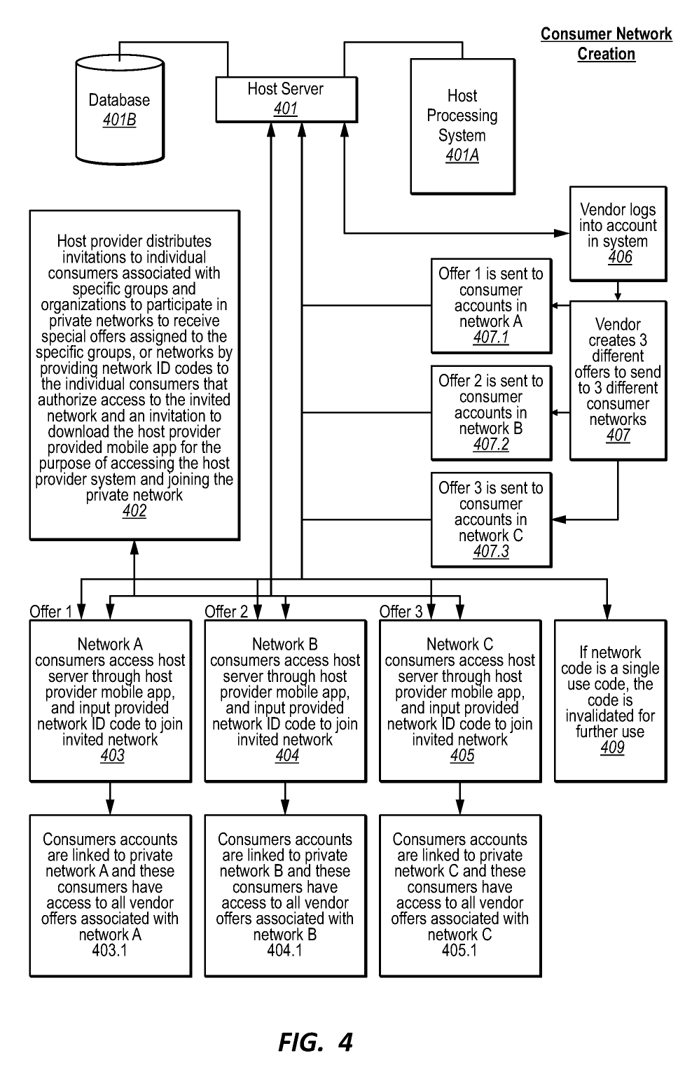

FIG. 4 illustrates an example method and system of consumer network creation in accordance with one or more embodiments. In particular, FIG. 4 illustrates the creation of consumer networks and the marketing of offers to chosen consumer networks by vendors. By physical, electronic or other means, the host provider distributes invitations to consumers containing special network codes to join specific networks that will allow the consumers to access offers for the specified network, said offers specifically created by vendors 402. By joining the network, consumers may receive special offers not available to the general public. A consumer may become a member of the invited network once the code is input in a specified field by the consumer through the mobile application on a data connected mobile computing device in communication with the host processing system 401A of host server 401.

Also illustrated in FIG. 4 are groups of consumers 403, 404, and 405 properly inputting network codes and joining network A, network B, and network C, respectively, and being linked to these networks to receive all offers from vendors targeted to networks A 403.1, B 404.1 and C 405.1. If the network code entered is a single-use code, the code is deactivated or invalidated from the host processing system 401A once it is correctly input into the mobile application and related consumer account and recognized by the system 409.

Further illustrated in FIG. 4 is a specific vendor logged in 406 creating three different offers to send to the three provided private networks 407. As shown, offer 1 is sent to consumer accounts associated with network A 407.1, offer 2 is sent to consumer accounts associated with network B 407.2, and offer 3 is sent to consumer accounts associated with network C 407.3. Consumers may then view and present for redemption the offer available through their respective networks, such as offer 1 for network A 403.1, offer 2 for network B 404.1, and offer 3 for network C 405.1. In this scenario the vendor was able to target three different offers to three different networks allowing the vendor to target offers to groups that might be most likely to use the provided offer. This also would give the vendor the opportunity to be more aggressive with offers to consumers belonging to networks that are likely to be more valuable customers or that might be consumers that the vendor is struggling to get in to the vendors locations. The vendor may then aggressively reach out to these consumers with more expensive offerings that the vendor may not want to make available to the general public or to other networks.

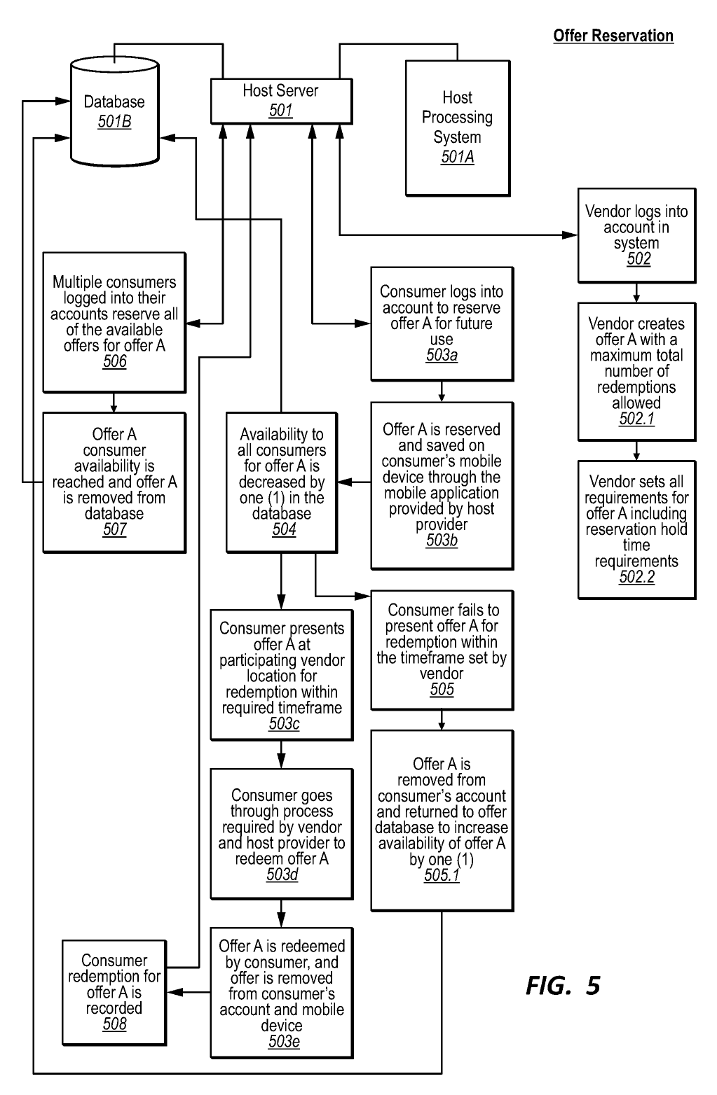

FIG. 5 illustrates an example method and system of offer reservation in accordance with one or more embodiments. In particular, FIG. 5 illustrates the process for reserving an offer with a maximum number of redemptions or reservations based on a first come, first serve basis for consumers for future use. In FIG. 5, the vendor logs into its vendor account through a remote vendor terminal (i.e., vendor computing device) 502 with the host server 501 incorporating the use of the host processing system 501A and the database 501B containing system instructions, routines, records, and data. The vendor then creates offer A with a finite number of total allowed redemptions 502.1. The vendor sets all of the other details and requirements for offer A and a maximum hold time by a consumer reserving offer A 502.2 and publishes the offer to desired networks.

FIG. 5 also illustrates a consumer logging into their consumer account and reserving offer A for future use 503a. Offer A is then reserved and saved on the consumers mobile computing device by way of the mobile application provided by the host provider 503b. The offer A is recorded by the host processing system 501A and the remaining availability of offer A is decreased by one (1) 504 in database 501B. The consumer then presents offer A at a participating vendor location for redemption within the time frame required by vendor 503c. Offer A is then redeemed by the consumer 503d and offer A is then removed from the Consumer's account on the host processing system 501A and from the mobile application on the mobile computing device utilized by the Consumer 503e. The redemption information is then recorded on the host processing system 501A for offer A 508.

In another scenario, the consumer fails to present offer A for redemption at a participating vendor location within the time frame granted for holding the offer in reservation 505. Offer A is removed from the consumer's account and returned to the database 501B to increase the availability of offer A by one (1) 505.1 for other consumers to redeem or reserve. Once multiple consumers reserve offer A 506 and the availability of offer A is reached, offer A is then removed from the database and no longer available for any consumer to use 507. This process allows a vendor to limit the number of offers provided to consumers to the desired results of the marketing campaign initiated by the vendor. The process also may increase consumer usage of the offer and the speed at which consumers patronize the vendor locations by creating a sense of urgency due to the fact that the offer has limited availability and the time frame to use the offer is limited.

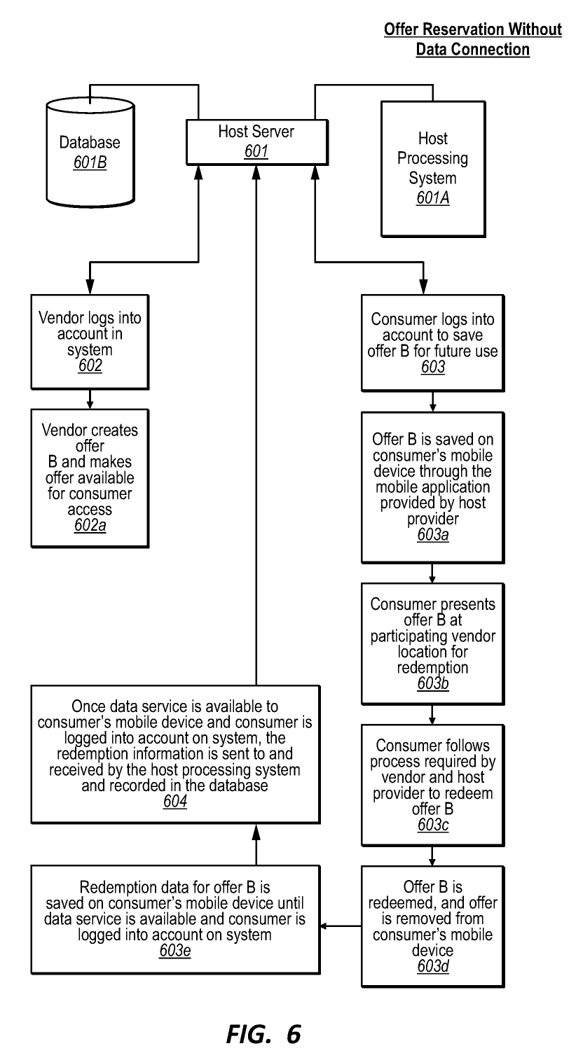

FIG. 6 illustrates an example method and system of offer reservation without a data connection in accordance with one or more embodiments. More specifically, FIG. 6 illustrates the process of reserving an offer to redeem at a future date where a data connection may be limited or unavailable. In FIG. 6, a vendor logs into its account from a remote vendor terminal 602 and creates and publishes offer B for consumer use 602a. A consumer with data connection on a mobile computing device logs into their account on host server 601, which includes host processing system 601A and database 601B, through the mobile application provided by the host provider and downloaded onto the consumer's mobile computing device to reserve offer B for future use where data service may not be available 603. Offer B is then saved on the consumer's mobile computing device through the downloaded mobile application provided by the host provider 603a. Later, the consumer without a data connection on their mobile computing device presents offer B at a participating vendor location for redemption 603b and follows the process required to redeem offer B 603c. Once offer B is redeemed, the offer is removed from the consumer's mobile computing device 603d. The redemption data is then saved on the consumer's mobile computing device 603e. Once the consumer is again connected to and logged into the host processing system 501A through the mobile application on the mobile computing device, the redemption information is automatically sent 604 with any other unrecorded redemptions to the host server 601 and updated in the database 601B.

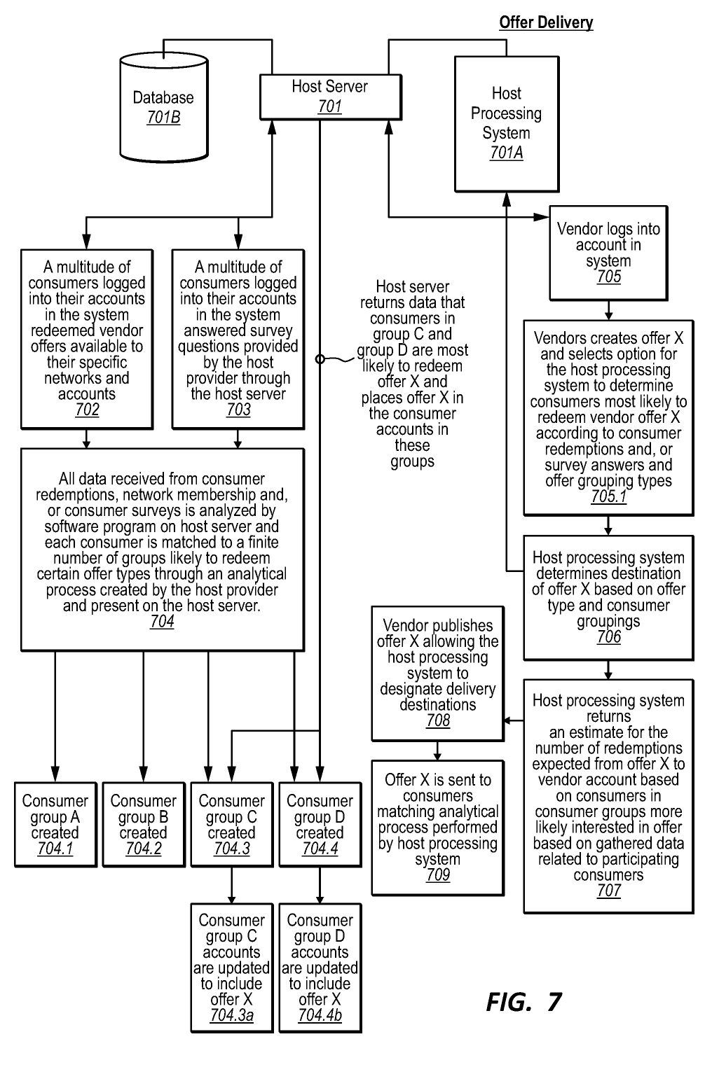

FIG. 7 illustrates an example method and system of offer delivery in accordance with one or more embodiments. In particular, FIG. 7 represents the delivery of offers based on analytical processes. In FIG. 7, the described processes are performed through a distributed network with hardware and software present on a host server 701 containing a host processing system 701A and a database 701B. Additionally, the described processes are performed in part by one or more mobile computing devices incorporating a mobile application provided by a host provider, the one or more mobile computing devices communicatively connected to the host processing system 701A.

FIG. 7 depicts a multitude of consumers logged into their consumer accounts in the host processing system 701A via a mobile application from a mobile computing device. The multitude of consumers are identified by network membership according to their consumer accounts in database 701B on host server 701 and their redeemed offers at various vendor locations 702. FIG. 7 also illustrates that a multitude of consumers who, while logged into the host processing system 701A, answer survey questions provided by the host server 701 as specified by the host provider or one or more vendors 703.

FIG. 7 further illustrates that all consumer data, including data gathered from past redemptions, which may be combined with data gathered from answered surveys, is combined, stored, and analyzed 704 by software present on the host server 701. This data is analyzed to create segmented groups of consumers as they may relate to their interest level in receiving certain offers, offer types from specific vendors, or offers from certain vendor types. The data analyzed and processed for the purpose of matching consumers with vendors, vendor types, offers, and offer types may also include data relating to defined redemption patterns, survey answers, and other data as they relate to specific networks to which individual consumers belong. As FIG. 7 shows, software present on the host server 701 with information gathered from the database 701B and initiated by the host processing system 701A segments consumers into four groups for matching consumers with vendors, vendor types, offers, and offer types, as shown by consumer group A 704.1, consumer group B 704.2, consumer group C 704.3, and consumer group D 704.4, respectively.

FIG. 7 also shows that a vendor logs into account on the host server 701 from a remote vendor terminal (e.g., vendor computing device) 705 and creates offer X 705.1. The vendor then chooses the option of allowing the host processing system 701A through software present on the host server 701 to perform analytical processes based on gathered consumer data to determine the destination of offer X based on the analytical process determining a group of consumers most likely to use offer X 706. The host processing system 701A provides results to the vendor account informing the vendor of the number of consumers and, in some cases, the consumer groups most likely to use offer X 707. The vendor then decides to publish offer X 708 to the destinations identified through the analytical processes performed by the host processing system 701A. Offer X is then sent to the designated consumers 709. In this scenario, the results provided by the host processing system 701A determine that the consumer groups most likely to use offer X are consumer group C 704.3 and consumer group D 704.4. Accordingly, offer X is sent only to the accounts of consumers found in consumer groups C 704.3a and D 704.4b.

FIG. 7 illustrates methods and systems that provide a significant advantage for vendors. Vendors may be able to better control the cost of advertising by sending offers of value to consumers that provide optimal results for cost versus return. For example, consumers in consumer group C 704.3 may likely respond to an offer of 15% off a purchase provided by a specific vendor, whereas consumer group B 704.2 may only respond to offers of 25% off or greater from the same vendor. Vendors can also feel confident that the offers they create and publish are well received by the consumers to whom they make offers available and that consumers are not frustrated by receiving offers that do not interest or incentivize them to redeem such offers.

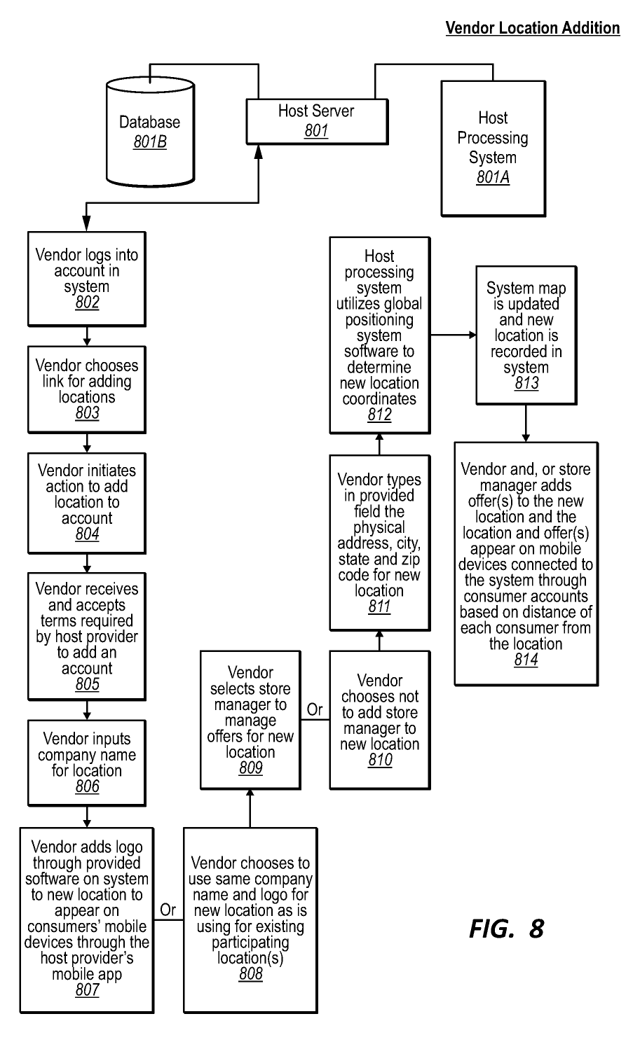

FIG. 8 illustrates an example method and system of vendor location addition in accordance with one or more embodiments. More specifically, FIG. 8 illustrates the permissions and processes involved for a vendor to add a vendor location to an existing vendor account. As FIG. 8 shows, a vendor logs into the vendor account 802 hosted on the host server 801, which includes a host processing system 801A and a database 801B. Once in the account, the vendor chooses the link for adding locations 803, initiates an action to add a location to the account 804, and accepts terms required by the host provider for adding locations to the account 805. The vendor then inputs the name (e.g., company name or location name) identifying the location 806. The vendor then may add a new logo for the location 807 to be viewed by consumers in their consumer accounts on mobile computing devices through the provided software found on the host server 801 or the vendor may choose to use an existing logo already in use for existing locations 808. The vendor may then select or add a store manager for the new location 809 who will have limited access to add and manage offers for the location or the vendor may proceed without adding a store manager 810. The vendor then identifies the location by adding in the physical address, city, state, and the zip code of the new location 811. The host processing system 801A through a global positioning system (GPS) software determines the physical coordinates for the location 812 and the map in the host processing system 801A is updated and the new location will appear in consumer accounts on connected mobile computing devices according to the distance of the consumer from the new vendor location 813 as soon as the vendor or the assigned store manager add offers to the location 814 that are directed to said consumers.

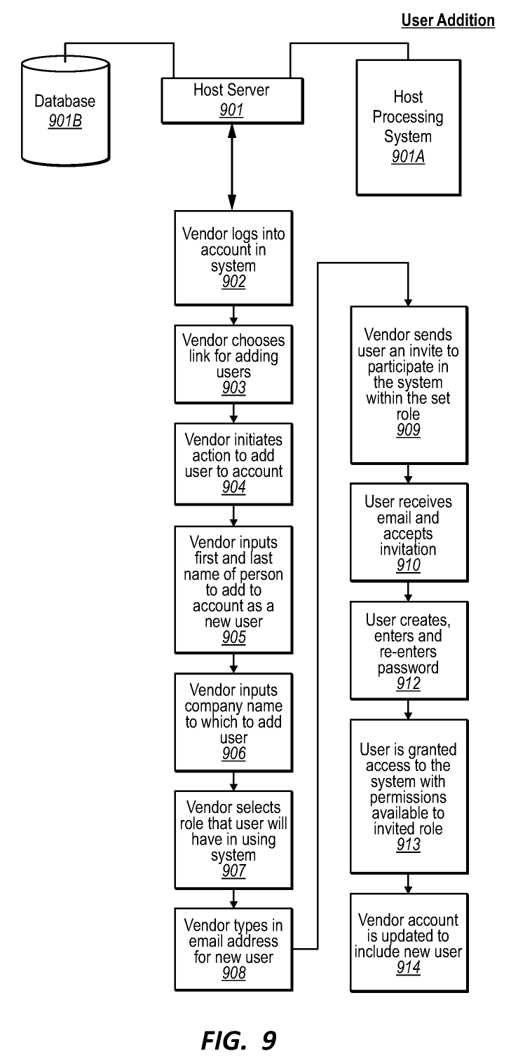

FIG. 9 illustrates an example method and system of user addition in accordance with one or more embodiments. In particular, FIG. 9 illustrates the process of a vendor adding a new user to its vendor account. As FIG. 9 shows, a vendor logs into the vendor account 902 hosted on the host server 901, which includes a host processing system 901A and database 901B. Vendor then chooses a link for adding a new user 903 and initiates an action for adding a new user to its vendor account 904. The vendor inputs the first and last names of the person being invited to participate 905, inputs the name of the company to which the user will be assigned for the purpose of adding and managing offers 906, selects the role the new user will have 907, and types in the email address for the person being invited to participate 908. The vendor submits the information and an invite is sent to the prospective new user via email, or other means 909. The user receives the invite and accepts the invitation to participate 910, creates, enters, and re-enters a password 912 required to access the host server 901 to access the host processing system 901A, and is then granted access within the scope of the permissions granted 913. The vendor account is then updated to include the new user 914.

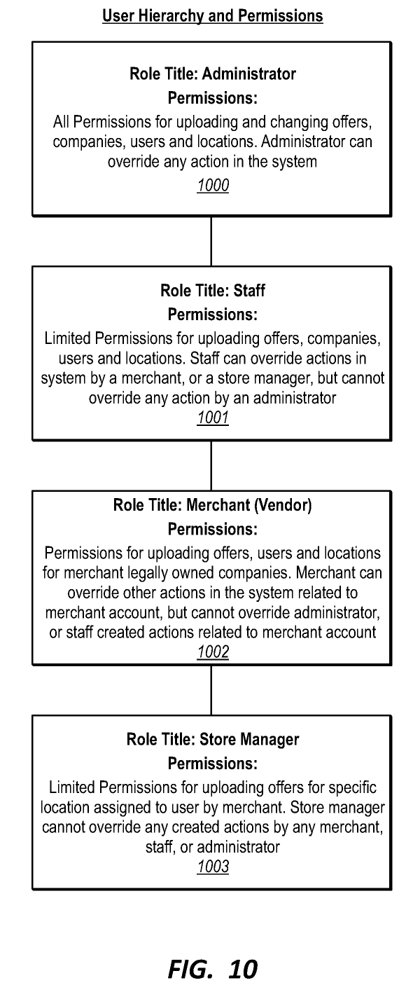

FIG. 10 illustrates an example user hierarchy and permissions in accordance with one or more embodiments. More specifically, FIG. 10 is a description of the hierarchy, roles, and permissions of the individuals participating in the system, such as the system exemplified by the host servers, databases, and host processing systems previously described. The Administrator 1000 has overriding control over the creation and management of all offers and the adding of users and of vendor locations in the system. Staff members 1001 have the permission to add companies, locations, users, and offers and can override actions by a merchant or store manager lower on the hierarchy. Staff members do not have permission to override actions initiated by an administrator and cannot add users as administrators or other users as staff members. Merchants (i.e., vendors) 1002 have the permission to create and manage offers, locations, and users related to the merchant account (i.e., vendor account). Merchants can add other individuals to participate also as a merchant to the merchant account with the same role and permissions of the initial merchant. Merchants may also add store managers. Merchants have overriding control over merchant accounts related to store managers. Merchants cannot override actions initiated by an administrator or staff member. Store managers 1003 have the permissions to add and manage offers for locations assigned to them by merchants, staff members, or administrators. Store managers do not have permissions to add users or locations. All offers created by store managers may be altered, changed, or removed by merchants, staff members, or administrators.

While not shown in FIG. 10, the system may provide for the creation of additional roles and levels of hierarchy. For example, a restaurant owner may franchise locations where merchants own the franchised locations. The restaurant owner may be included in the hierarchy to create, control, and publish offers for all franchise locations. A merchant (i.e., vendor) may also employ an advertising agency to control all marketing for a group of merchant locations. The advertising agency may be given managing control over creating, publishing, and managing offers for all related merchant locations. The scope of the hierarchy and permissions described in FIG. 10 are meant to describe how the hierarchy works, but does not entail all possible combinations of hierarchy, roles, and permissions that may be granted through the system.

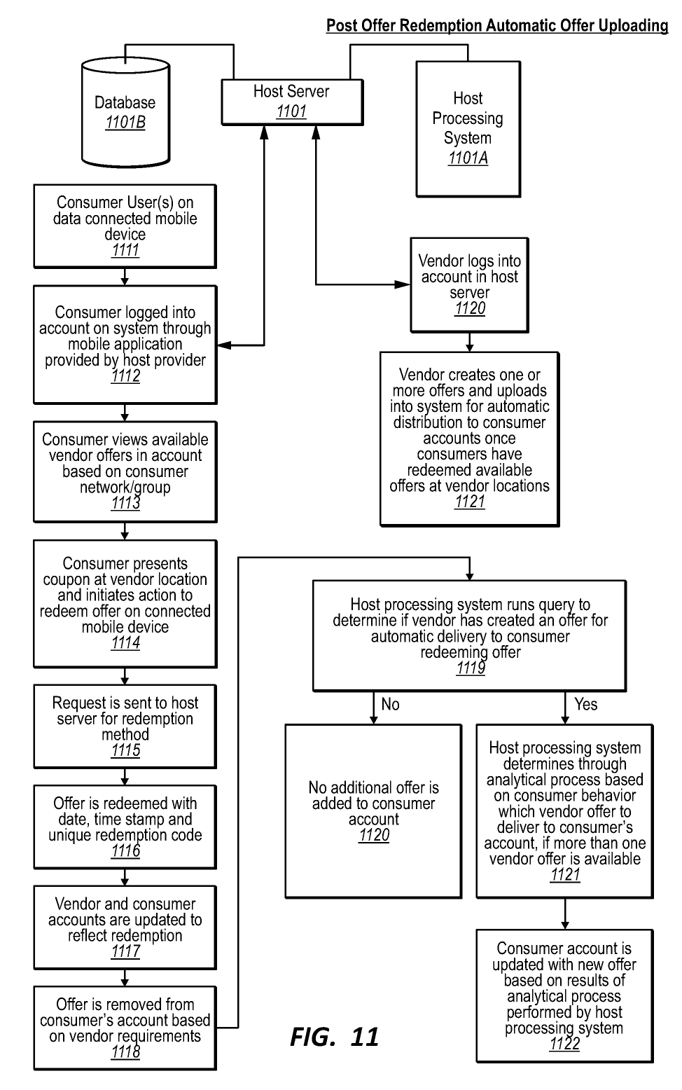

FIG. 11 illustrates an example method and system of post-offer redemption automatic offer uploading in accordance with one or more embodiments. In particular, FIG. 11 illustrates a process for automatically updating consumer accounts with offers created by vendors after consumers have redeemed offers from the same vendors. As part of this process, a vendor logs into its vendor account 1120 on host server 1101, which includes host processing system 1101A and database 1101B. The vendor then creates and submits to add to database 1101B one or more offers to be automatically added by host processing system 1101A to consumer accounts resident in database 1101B after an existing offer available to consumers in their consumer accounts from the same vendor has been redeemed by a consumer.

As FIG. 11 shows, a consumer on a data connected mobile computing device 1111 logs into their account on the system through a mobile application 1112. The consumer views locations and offers of vendors made available to the consumer by the vendors according to the network to which the consumer is assigned 1113. The consumer presents an offer for redemption at a participating vendor location of vendor and initiates an action to redeem the offer 1114. A request is then sent 1115 to the host server 1101 for a redemption method and the offer is then redeemed accordingly at the vendor location 1116. The vendor and consumer accounts are then updated to reflect the redemptions 1117. The redeemed offer is then removed from the consumer's account based on the availability of the offer as set by the vendor 1118. The host processing system 1101A then runs a query to determine if the vendor has created an additional offer for automatic delivery to the consumer account as a result of the one offer being redeemed 1119. If no additional offer has been created for automatic delivery, no offer is automatically added to the consumer account 1120. If an offer has been created for automatic delivery, the host processing system 1101A delivers the new offer to the consumer account of the consumer redeeming the offer. If more than one offer has been created by the vendor, the offer is chosen and delivered to the consumer account based on a consumer account analysis. This consumer account analysis is performed by software present on the host processing system 1101A through analytical processes and for the purpose of determining the calculated most effective offer to automatically add to the account of the consumer redeeming the first offer 1121. The consumer account resident on database 1101B is then updated with the new offer 1122. The processes described herein may partially be performed by staff members or administrators, as well as by the vendors. By incorporating these processes, vendors will benefit by ensuring that consumers always have an offer from the vendor to use and that the offers are delivered to consumers based on consumer behaviors or surveys to insure the best results for the vendor in consumer redemptions.

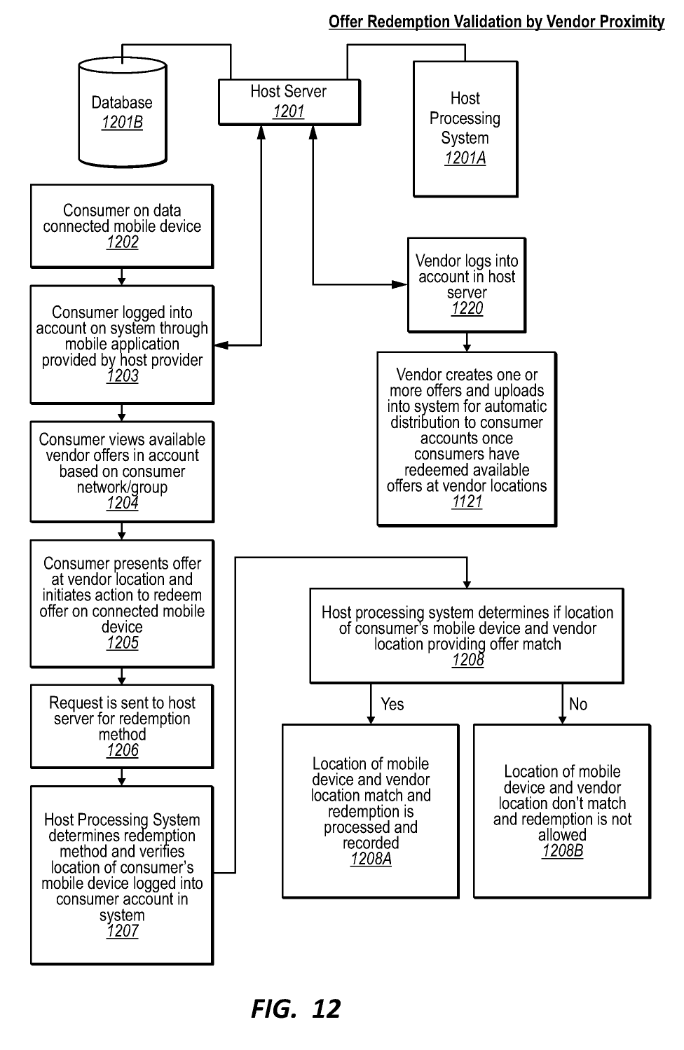

FIG. 12 illustrates an example method and system of offer redemption validation by vendor proximity in accordance with one or more embodiments. More specifically, FIG. 12 illustrates a consumer on a data connected mobile computing device 1202 logs into 1203 the host server 1201, which includes host processing system 1201A and database 1201B, through a mobile application provided by the host provider and present on the consumer's mobile computing device. The consumer has allowed permissions for the host server 1201 to detect the location of the consumer mobile computing device through the mobile application provided by the host provider. The consumer views available offers from vendors 1204. The consumer presents an offer at a participating vendor location for redemption 1205 and a request is sent to the host server 1201 for a redemption method 1206 and location verification. The host processing system 1201A determines the redemption method required by the vendor and verifies the location of the mobile computing device being used by the consumer 1207. The host processing system 1208 determines if the location coordinates of the consumer mobile computing device matches, or is close enough, to the location coordinates of the vendor location at which the offer is set to redeem 1208. If the locations do not match or are not close enough, the redemption is not allowed 1208B. If the locations match or are close enough 1208A, the redemption is processed according to vendor requirements and recorded in database 1210B on the host server 1210. This ensures that redemptions of offers posted to vendor accounts are all valid redemptions and that consumers or vendor employees are not falsely redeeming offers for some form of personal gain. For example, a consumer may initiate a false redemption of an offer in order to receive a different coupon from the vendor providing the offer. Location detection methods may use third party software, host provider created software, or a combination of third party software and host provider created software.

Note that the host server, host processing system, and database shown in all figures may include one or more servers, databases, and processing systems connected through a distributed data processing network on multiple computing devices for the purpose of providing all of the described systems, processes, methods, components, modules, options, computations, analytics, and delivery as detailed herein. The mobile application referred to herein may be one or more mobile applications. The mobile computing devices referred to herein may be any type of mobile computing device with a data connection able to perform, enable, or facilitate the described systems and methods. Software referred to herein may be software purchased from, or contracted from third parties, or may be software created by the host provider. The mobile application referred to herein may be a native application for a specific brand of mobile computing devices and type of mobile computing devices or may be a web application operating through a web browser on a mobile computing device or any other type of suitable software or hardware application operating on a mobile computing device.

Embodiments may comprise or use a special purpose or general-purpose computer including computer hardware, such as, for example, one or more processors and system memory, as discussed in greater detail below. Embodiments within the scope also include physical and other computer-readable media for carrying or storing computer-executable instructions or data structures. In certain particular embodiments, one or more of the processes described herein may be implemented at least in part as instructions embodied in a non-transitory computer-readable medium and executable by one or more computing devices. In general, a processor (e.g., a microprocessor, etc.) receives instructions, from a non-transitory computer-readable medium (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media devices. Computer-readable media that carry computer-executable instructions are transmission media. Thus, by way of example, and not limitation, one or more embodiments can comprise at least two distinctly different kinds of computer-readable media: non-transitory computer-readable storage media devices and transmission media.

Non-transitory computer-readable storage media devices include RAM, ROM, EEPROM, CD-ROM, solid state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems or modules or other electronic devices. When information is transferred or provided over a network or another communications connection (either hardwired, wireless, or a combination of hardwired or wireless) to a computer, the computer properly views the connection as a transmission medium. Transmission media can include a network or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media devices or vice versa. For example, computer-executable instructions or data structures received over a network or data link can be buffered in RAM within a network interface module (e.g., a NIC), and then eventually transferred to computer system RAM or to less volatile computer storage media devices at a computer system. Thus, it should be understood that non-transitory computer-readable storage media devices can be included in computer system components that also or even primarily use transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general purpose computer to turn the general purpose computer into a special purpose computer implementing elements of one or more embodiments. The computer executable instructions may be, for example, binaries, intermediate format instructions such as assembly language, or even source code. Although the subject matter has been described in language specific to structural features or methodological acts, it is to be understood that the subject matter defined in the appended claims is not necessarily limited to the described features or acts described above. Rather, the described features and acts are disclosed as example forms of implementing the claims.

Those skilled in the art will appreciate that the one or more embodiments may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. One or more embodiments may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments can also be implemented in cloud computing environments. In this description and the following claims, cloud computing is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (SaaS), Platform as a Service (PaaS), and Infrastructure as a Service (IaaS). A cloud computing model can also be deployed using different deployment models such as private cloud, community cloud, public cloud, hybrid cloud, and so forth. In this description and in the claims, a cloud computing environment is an environment in which cloud computing is employed.

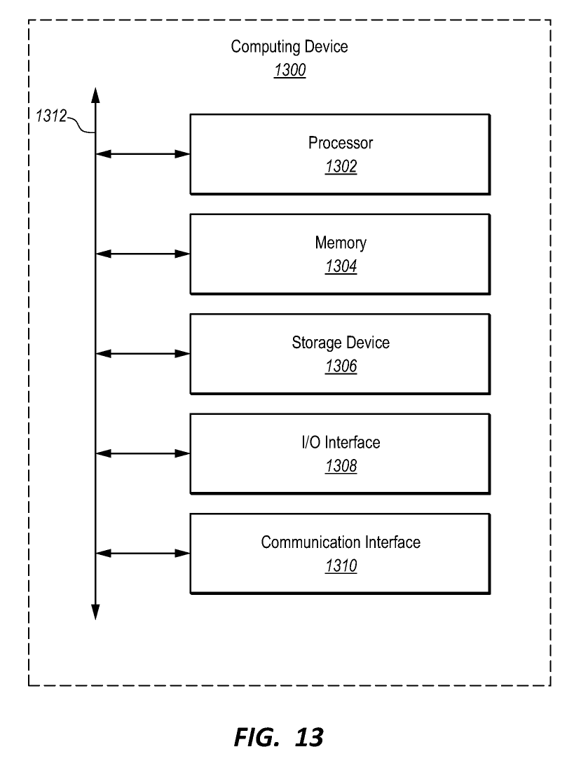

FIG. 13 illustrates a block diagram of an exemplary computing device in accordance with one or more embodiments. More specifically, FIG. 13 illustrates, in block diagram form, an exemplary computing device 1300 that may be configured to perform one or more of the processes described above. One will appreciate that the host servers, consumer mobile computing devices, and vendor terminals or vendor computing devices of the one or more embodiments can each comprise implementations of the data-computing device 1300. As shown by FIG. 13, the computing device can comprise a processor 1302, memory 1304, a storage device 1306, an I/O interface 1308, and a communication interface 1310. While an exemplary computing device 1300 is shown in FIG. 13, the components illustrated in FIG. 13 are not intended to be limiting. Additional or alternative components may be used in other embodiments. Furthermore, in certain embodiments, a computing device 1300 can include fewer components than those shown in FIG. 13. Components of computing device 1300 shown in FIG. 13 will now be described in additional detail.

In particular embodiments, processor(s) 1302 includes hardware for executing instructions, such as those making up a computer program. As an example and not by way of limitation, to execute instructions, processor(s) 1302 may retrieve or fetch the instructions from an internal register, an internal cache, memory 1304, or a storage device 1306 and decode and execute them. In particular embodiments, processor(s) 1302 may include one or more internal caches for data, instructions, or addresses. As an example and not by way of limitation, processor(s) 1302 may include one or more instruction caches, one or more data caches, and one or more translation lookaside buffers (TLBs). Instructions in the instruction caches may be copies of instructions in memory 1304 or storage device 1306.

The computing device 1300 includes memory 1304, which is coupled to the processor(s) 1302. The memory 1304 may be used for storing data, metadata, and programs for execution by the processor(s) 1302. The memory 1304 may include one or more of volatile and non-volatile memories, such as Random Access Memory (RAM), Read Only Memory (ROM), a solid state disk (SSD), Flash, Phase Change Memory (PCM), or other types of data storage. The memory 1304 may be internal or distributed memory.

The computing device 1300 includes a storage device 1306 for storing data or instructions. As an example and not by way of limitation, storage device 1306 can comprise a non-transitory storage medium described above. The storage device 1306 may include a hard disk drive (HDD), a floppy disk drive, flash memory, an optical disc, a magneto-optical disc, magnetic tape, or a Universal Serial Bus (USB) drive or a combination of two or more of these. Storage device 1306 may include removable or non-removable (or fixed) media, where appropriate. Storage device 1306 may be internal or external to the computing device 1300. In particular embodiments, storage device 1306 is non-volatile, solid-state memory. In particular embodiments, storage device 1306 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory, or a combination of these.

The computing device 1300 also includes one or more input or output (I/O) devices/interfaces 1308, which are provided to allow a user to provide input to, receive output from, and otherwise transfer data to and from the computing device 1300. These I/O devices/interfaces 1308 may include a mouse, keypad or a keyboard, a touch screen, camera, optical scanner, network interface, modem, other known I/O devices or a combination of such I/O devices/interfaces 1308. The touch screen may be activated with a stylus or a finger.

The I/O devices/interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 1308 is configured to provide graphical data to a display for presentation to a user. The graphical data may be representative of one or more graphical user interfaces or any other graphical content as may serve a particular implementation.

The computing device 1300 can further include a communication interface 1310. The communication interface 1310 can include hardware, software, or both. The communication interface 1310 can provide one or more interfaces for communication, such as, for example, packet-based communication, between the computing device 1300 and one or more other computing devices or one or more networks. As an example and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI.

This disclosure contemplates any suitable network and any suitable communication interface 1310. As an example and not by way of limitation, computing device 1300 may communicate with an ad hoc network, a personal area network (PAN), a local area network (LAN), a wide area network (WAN), a metropolitan area network (MAN), or one or more portions of the Internet, or a combination of two or more of these. One or more portions of one or more of these networks may be wired or wireless. As an example, computing device 1300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 1300 may include any suitable communication interface 1310 for any of these networks, where appropriate.

The computing device 1300 can further include a bus 1312. The bus 1312 can comprise hardware, software, or both that couples components of computing device 1000 to each other. As an example and not by way of limitation, bus 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

A network application can comprise an incentive marketing networking system that, as an example, can include a host server having a host processing system and a database, as described with respect to one or more embodiments described with respect to the figures. An incentive marketing networking system may enable its users (such as persons or organizations, like vendors and consumers) to interact with the system and with each other. The incentive marketing networking system may, with input from a user, create and store in the incentive marketing networking system a user profile associated with the user (e.g., for a vendor or a consumer). The user profile may include demographic information, communication-channel information, information on personal interests of the user, and information on the users current and prior offers or current and prior offer redemptions. The incentive marketing networking system may also, with input from a user, create and store a record of relationships of the user with other users of the incentive marketing networking system, as well as provide services (e.g., promotional event organization, messaging, payments, or advertisements) to facilitate interaction between or among users, such as vendors and consumers.

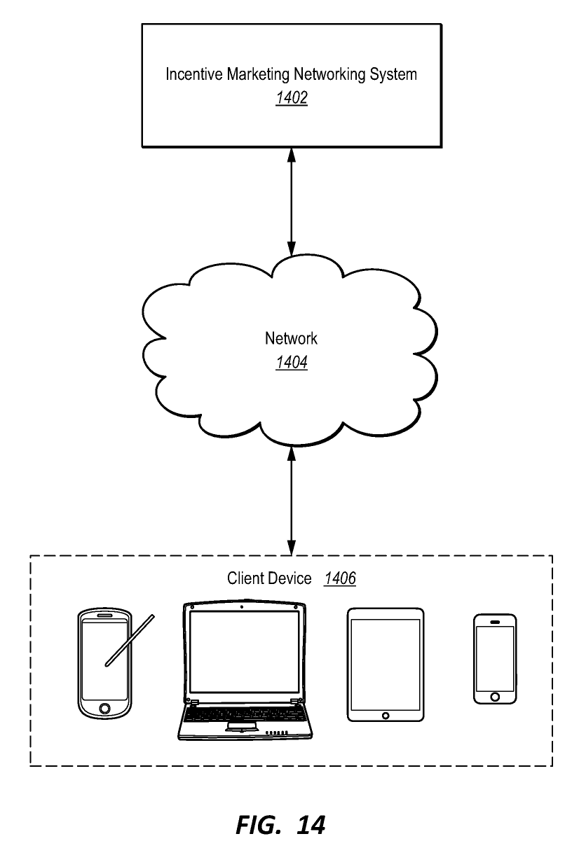

FIG. 14 illustrates an example network environment of an incentive marketing networking system in accordance with one or more embodiments. In particular embodiments, an incentive marketing networking system 1402 may comprise one or more data stores. In particular embodiments, the incentive marketing networking system 1402 may store any information relating to users (e.g., vendors, vendor employees, and consumers).

Also in particular embodiments, the incentive marketing networking system 1402 may comprise one or more computing devices (e.g., servers) hosting functionality directed to operation of the incentive marketing networking system. A user of the incentive marketing networking system 1402 may access the incentive marketing networking system 1402 using a client device such as client device 1406. In particular embodiments, the client device 1406 can interact with the incentive marketing networking system 1402 through a network 1404.

The client device 1406 may be a desktop computer, laptop computer, tablet computer, personal digital assistant (PDA), in- or out-of-car navigation system, smart phone or other cellular or mobile phone, or mobile gaming device, other mobile device, or other suitable computing devices. Client device 1406 may execute one or more client applications, such as a web browser (e.g., Microsoft Windows Internet Explorer, Mozilla Firefox, Apple Safari, Google Chrome, Opera, etc.) or a native or special-purpose client application (e.g., a mobile application, like 2for1 for iPhone or iPad, 2for1 for Android, etc.), to access and view content over a network 1404.

Network 1404 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of such networks) over which client devices 1406 may access the incentive marketing networking system 1402.

While these methods, systems, and user interfaces use both publicly available information, as well as information provided by users of the incentive marketing networking system, all use of such information is to be explicitly subject to all privacy settings of the involved users and the privacy policy of the incentive marketing networking system as a whole.

In the foregoing specification, various embodiments have been described with reference to specific exemplary embodiments thereof. Various embodiments and aspects are described with reference to details discussed herein, and the accompanying drawings illustrate the various embodiments. The description above and drawings are illustrative and are not to be construed as limiting. Numerous specific details are described to provide a thorough understanding of various embodiments.

One or more embodiments may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1.-20. (canceled)

21. A method for managing electronic computer-based incentive marketing campaigns comprising:
creating an offer to motivate consumers to make purchases from a vendor associated with a vendor account, the offer created based on offer information received from the vendor account;
receiving, from the vendor account, an indication of a network to which the offer is to be distributed;
determining a network identification code that identifies the network;
receiving, from a mobile application associated with a consumer account, an indication of the network identification code that identifies the network;
associating the consumer account with the network based on receipt of the indication of the network identification code that identifies the network;
distributing the offer to the consumer account based on a determination that the consumer account is associated with the network to which the offer is to be distributed;
receiving a request to redeem the offer for the consumer account; and
validating redemption of the offer based on the determination that the consumer account is associated with the network to which the offer is to be distributed.

22. The method as recited in claim 21, further comprising providing a vendor portal that facilitates the input of information related to creating, publishing, and redeeming offers.

23. The method as recited in claim 22, further comprising creating one or more vendor locations based on vendor location information received from the vendor account, wherein the vendor location information includes physical addresses where offers of the vendor are redeemable.

24. The method as recited in claim 23, further comprising creating a vendor profile based on vendor account information received from the vendor account, wherein the vendor account information includes at least one of logos, artwork, images, or text related to the vendor.

25. The method as recited in claim 24, wherein the offer information includes at least one of text wording of the offer, an offer start date, an offer expiration date, or a number of redemptions of the offer available per consumer account.

26. The method as recited in claim 21, further comprising:
receiving, from the vendor account, a request to immediately publish the offer to one or more consumer accounts; and
in response to the receipt of the request to immediately publish the offer, providing the offer to a mobile application associated with each of the one or more consumer accounts.

27. The method as recited in claim 21, further comprising:
receiving, from the vendor account, a request for future publication of the offer to one or more consumer accounts; and
providing the offer to a mobile application associated with each of the one or more consumer accounts in accordance with the request for future publication of the offer.

28. The method as recited in claim 27, wherein the request for future publication of the offer specifies a date and time for publication of the offer to the one or more consumer accounts.

29. The method as recited in claim 27, wherein the request for future publication of the offer specifies a period of time that must elapse before publication of the offer to the one or more consumer accounts.

30. A method for managing electronic computer-based incentive marketing campaigns comprising:
creating an offer to motivate consumers to make purchases from a vendor associated with a vendor account, the offer created based on offer information received from the vendor account;
receiving, from the vendor account, an indication of a network to which the offer is to be distributed;
determining a network identification code that identifies the network;
receiving, from a mobile application associated with a consumer account, an indication of the network identification code that identifies the network;
associating the consumer account with the network based on receipt of the indication of the network identification code that identifies the network;
distributing the offer to the consumer account based on a determination that the consumer account is associated with the network to which the offer is to be distributed;
receiving an initial request to redeem the offer for the consumer account;
validating redemption of the offer based on the determination that the consumer account is associated with the network to which the offer is to be distributed;
determining that the offer is available for multiple redemptions by the consumer account; and
denying a subsequent request to redeem the offer for the consumer account until a pre-determined period of time has elapsed since the initial request to redeem the offer for the consumer account.

31. The method as recited in claim 30, wherein determining a network identification code that identifies the network further comprises generating the network identification code at a host server.

32. The method as recited in claim 30, wherein determining a network identification code that identifies the network further comprises receiving data input that specifies the network identification code, wherein the data input is received from one of the vendor account or a host provider.

33. The method as recited in claim 30, further comprising:
receiving, from the mobile application associated with the consumer account, a request to reserve the offer;
reserving the offer for redemption by the consumer account;
determining that a pre-determined period of time has elapsed since the receipt of the request to reserve the offer; and
removing the offer from the consumer account based on the determination that the pre-determined period of time has elapsed since the receipt of the request to reserve the offer; and
placing the offer into a pool of offers available for use by other consumer accounts.

34. The method as recited in claim 30, further comprising receiving, from the vendor account, a selection of a redemption process to apply to the offer.

35. The method as recited in claim 34, wherein the redemption process further comprises sending, to the mobile application associated with the consumer account, a request to display a notification of redemption that causes the mobile application to display a redemption code.

36. The method as recited in claim 35, further comprising receiving, from the vendor account, information indicating that the redemption code has been scanned by a vendor computing device located at a vendor location associated with the vendor account of the vendor.

37. The method as recited in claim 34, wherein the redemption process further comprises receiving, from the mobile application associated with the consumer account, information indicating that a redemption code displayed at a vendor location associated with the vendor account of the vendor has been scanned by a consumer computing device having the mobile application associated with the consumer account.

38. The method as recited in claim 34, wherein the redemption process further comprises determining that a consumer computing device is in communication with a vendor computing device located at a vendor location associated with the vendor account of the vendor, the consumer computing device having the mobile application associated with the consumer account.

39. A system for managing electronic computer-based incentive marketing campaigns comprising:
one or more server computing devices executing a network application; and
a non-transitory storage medium comprising instructions that, when executed by the one or more server computing devices, cause the system to:
create an offer to motivate consumers to make purchases from a vendor associated with a vendor account, the offer created based on offer information received from the vendor account;
receive, from the vendor account, an indication of a network to which the offer is to be distributed;
determine a network identification code that identifies the network;
receive, from a mobile application associated with a consumer account, an indication of the network identification code that identifies the network;
associate the consumer account with the network based on receipt of the indication of the network identification code that identifies the network;
distribute the offer to the consumer account based on a determination that the consumer account is associated with the network to which the offer is to be distributed;
receive a request to redeem the offer for the consumer account; and
validate redemption of the offer based on the determination that the consumer account is associated with the network to which the offer is to be distributed.

40. The system as recited in claim 39, wherein the instructions that, when executed by the one or more server computing devices, further cause the system to provide a vendor portal that facilitates the input of information related to creating, publishing, and redeeming offers.
